(19) United States
(12) Patent Application Publication
(10) Pub. No.: US 2005/0136211 A1
(43) Pub. Date: Jun. 23, 2005

(54) Light shielding enclosure

(76) Inventors: Michael R. McGovern, Rochester, NY (US); Robert L. Huseby, Fairport, NY (US); Edward B. Richter, Rochester, NY (US); Kelvin P. Hill, Rochester, NY (US); Thomas M. Frank, Fairport, NY (US); Diane B. Winter, Rochester, NY (US)

Correspondence Address: Pamela R. Crocker;Patent Legal Staff, Eastman Kodak Company, 343 State Street, Rochester, NY, 14650-2201, US

(21) Appl. No.: 10/740,209

(22) Filed: Dec. 18, 2003

(51) Int. Cl. B32B 33/00; G03B 17/26

(52) U.S. Cl. 428/90; 396/513

(57) ABSTRACT

A light shielding enclosure has a pair of teremp from a plurality of substrates with a non-woven flocked pile fiber bonded to a plurality of substrates that in turn are then bonded to a shell plate that forms the tubular geometry of the resultant patrone for housing photographic film. The resultant uniform flocked and random pile structure of the properly dyed teremp pile provides a distinct structural light shielding member by this invention. The said teremps in a continuous length along the resulting formed film exit slot along the longitudinal direction maintain a contact at that location member. The continuous length teremps are bonded to the opposite side edges. The non-woven flocked pile teremp has more uniform pile height and greatly reduced loose fibers and long fibers.

### CROSS-REFERENCE TO RELATED APPLICATIONS

The present application is related to U.S. Serial No.______, filed concurrently herewith, of Michael R. McGovern and Edward B. Richter, entitled “An Improved Cartridge For Photographic Film Product”, Atty. Docket No. 87509/CEB; and

U.S. Serial No.______, filed concurrently herewith, of Michael R. McGovern and Edward B. Richter, entitled “Method Of Making An Enclosure For Storing And Accessing Environmentally Sensitive Product Therein”, Atty. Docket No. 87510/CEB.

### FIELD OF THE INVENTION

The invention relates generally to the field of a light sensitive enclosure. More particularly, the invention concerns a method of making an improved light sensitive enclosure, such as a cartridge or cassette for photographic film product, having an improved light-shielding member arranged in an ingress/egress exit slot.

### BACKGROUND OF THE INVENTION

Light protected enclosures or cartridges for photographic film product have conventionally included some sort of light barrier plush in the ingress/egress slot to prevent premature exposure of the product to deleterious light. A well-recognized continuing problem in the art is how to significantly improve the film keeping condition when stored in the cartridge, particularly from environmental elements such as deleterious light and airborne particles. There is a need to accomplish this task in a manner that does not in any way damage the film.

A multitude of dyed woven fabrics are currently employed in the service of providing a teremp or light shielding benefit to photographic film cassettes. Some examples include, but are not limited to, a woven rayon backing with a woven polyamide pile at a set pile height and denier so specified to provide sufficient light shielding integrity to light sensitive photographic films. In most cases the fabric is treated with an anti-static agent to reduce or control any accumulation of tribo-electric charges that results from the manufacturing and assembly procedures. A plurality of anti-static fiber treatments are available depending on the fiber selection. Thus, it is common to have different procedures with (for example) a polyamide nylon 6/6 fiber versus that of a polyethylene terphthalate (polyester) fiber. Resultant levels of conductivity will also contribute to loose fiber adhesion and thus affect the overall photographic performance of the entire system in a negative way.

The creation of long fibers originating in the pile portion of the teremp creates serious problems that the current invention overcomes. Typically, slitting and shaving techniques are used today in all woven and knitted processes. Regardless of the methods employed in the current technology, long fibers are generated and some long fibers survive all attempts at removal.

Certain velvets are also examples of these teremps that are costly to produce and can be prone to failure due to the non-robust nature of the choice methods of current manufacturing of these woven products. Produced in wide roll formats, they must be slit to the appropriate width for these teremp applications for photographic film. The slitting process is one that makes use of different technologies. One common method is the use of an ultrasonic knife that slits the wide roll web into the desired width while at the same time sealing the “freshly created edge” so as to prevent or at least minimize the generation of loose fibers, the liberation of any long fibers and/or creation of tufts of loose fibers. Non-ultrasonic methods can and do produce a multitude of loose fibers, long fibers and even tufts of fiber that are most difficult to remove even in vacuuming processes. During actual use these loose filaments can be dislodged and create severe contamination in photographic systems such as cameras. A sufficient amount of this contamination can also damage the film and ultimately contaminate the photographic film processing process causing severe quality and economic burdens on the part of individuals in the trade.

The severity of the loose and long fiber issue has been evolving over time as camera designs have changed and miniaturization has attained more market value to consumers. As cameras have become smaller the distance or gap between the aperture and the position of the light lock material on the cartridge or cassette is decreasing to where some serious quality problems have resulted when loaded into photographic systems such as cameras.

There have been several known attempts in the art to impact this problem including that which is taught in U.S. Pat. No. 5,246,521 (Shimura et al.) wherein both knit and woven teremps can and are employed in providing this light shielding function for photographic film cartridges. Shimura et al. also teach that the angle or direction of the teremp pile is very important in this function.

In U.S. Pat. No. 5,271,983 (Ise et al.), the use of a formula developed to maximize the pile yarn density by passing pile yarns between the needle loop and the sinker loop of the ground fabric or thru the use of special yarns such as Raschel yarns is described. Ise et al. also discloses the use of a hydrophilic anti-static polymer coating on the surface of the fabric.

Further, in U.S. Pat. No. 4,928,826 (Shibazaki et al.), the use of a specialty developed patrone or cartridge is disclosed for packaging roll film. This patent also teaches the use of a woven light lock velvet material of diacetate pile on a rayon fabric backing.

In U.S. Pat. No. 4,034,929 (Ebner, Jr.) a container for dispensing sheet material from a roll receiver interior of the container is disclosed wherein an exit slot needs some sort of light shielding to protect the product therein.

Moreover, U.S. Pat. No. 4,730,778 (Akao et al.) teaches the use of specialty yarns such as Milanese, Raschel, or Tricot fabric teremps containing polyesters, acrylics, and nylons.

Still further, U.S. Pat. No. 4,988,054 (Morse et al.) discloses a light lock material of a polyurethane foam having nylon overlay. Perforated photographic film would cause serious abrasion damage to the polyurethane foam resulting in excessive contamination in the patrone and/or camera. There is also compression set concerns with the use of any foamed polymer system on the shell plate in this application all of which are overcome by this invention. In this embodiment the invention utilized a thickness of foamed material that would be impractical in any 35 mm photographic teremp light shielding apparatus.

In each of the above-cited developments, the light shielding teremp is a fabric combination of a ground or backing with a pile that is generated by either a woven or knitted process. This kind of light shielding teremp is well known to pose the risk of unacceptable levels of light penetration into the cassette thereby exposing the photographic film product to the potential risk of damage.

Therefore, a need persists in the art for a novel non-woven flocked material arranged in the ingress/egress slot that would significantly improve the light barrier protection for the photographic film product.

### SUMMARY OF THE INVENTION

It is therefore, an object of the invention to provide a light shielding enclosure for storing and accessing environmentally sensitive product, such as photographic film.

Another object of the invention is to provide a light shielding enclosure that utilizes flocked pile fibers in the ingress/egress slot for blocking light and other particulate matter from penetrating the enclosure.

It is a feature of the invention that a light shielding enclosure for an environmentally sensitive product has an ingress/egress slot having bonded to opposite faces thereof a frocked pile fiber material that prevents light and other deleterious particulates from penetrating the enclosure.

The present invention is directed to overcoming one or more of the problems set forth above. Briefly summarized, according to one aspect of the present invention, a light shielding enclosure contains a body portion for enclosing a light sensitive product and an exit slot formed in the body portion for accessing the light sensitive product. The exit slot has opposing light lock members thereon, wherein each one of the light lock members comprise closely spaced flocked pile material configured for resisting light penetration into the enclosure.

Therefore, the present invention has numerous advantageous over the prior art including: the flocked material with its resulting random structure of the pile relative to a woven fabric provides significantly improved light blocking qualities; the flocking can also be applied to a plurality of substrates, including but not limited, to a woven fabric backing, a rubber or elastomeric sheet and various plastic films; the flocked material provides an significant economic advantage over the current woven light-shielding members and in particular over the use of expensive velvet. Other significant advantages includes the elimination of the individual loose fibers, long fibers or tufts of loose fibers that are generated which can be mechanically removed with a sufficient pile height on a plurality of substrates that lends more versatility to the use of a non-woven product. Furthermore, there is a huge advantage with the current invention in that the flocking process will yield much greater uniformity and consistency in both the morphology and the overall length of the generated pile length that translates directly to the pile height.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a perspective view of a film cartridge with a flocked pile fiber in the ingress/egress slot pursuant to a preferred embodiment of the invention; (fibers not shown for clarity)

FIG. 2 is an exploded view of a partial film cartridge of the invention;

FIG. 3 is a perspective view of enlarged cartridge of FIG. 1 depicting the ingress/egress slot bearing flock pile material on opposing faces according to the invention;

FIG. 4 is an enlarged view of the cartridge of FIG. 3 showing the film in the frocked fiber material of the ingress/egress slot; (A portion of the light lock members have been removed to allow viewing into the magazine)

FIG. 5 is a diagram of a process of flocking a substrate for application to the ingress/egress slot of the invention;

FIG. 6 is a perspective view of a partial flocked fiber material arranged on a substrate of the invention;

FIG. 7 is a scanning electron micrograph of flocked pile fiber material used in the invention; and,

FIG. 8 is a scanning electron micrograph of a non-flocked pile fiber material.

### DETAILED DESCRIPTION OF THE INVENTION

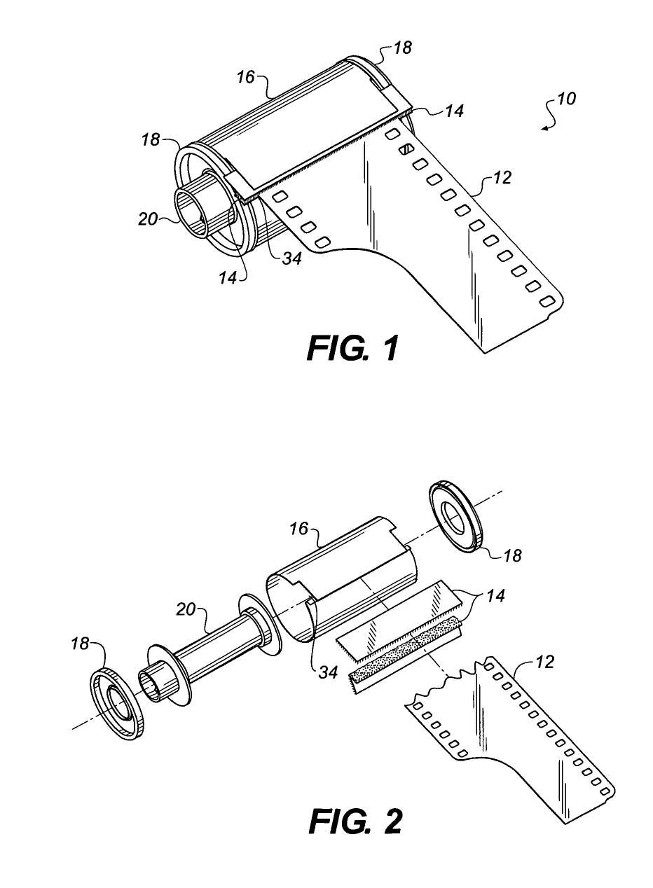

Turning now to the invention, and in particular to FIGS. 1-2, an improved cartridge 10 for photographic film product (such as 35 mm film) is illustrated. According to FIG. 1, cartridge 10 has a generally tubular shaped body portion 16 for enclosing the photographic film product 12, a rotatable film spool 20 arranged in the body portion 16 and end caps 18 and an ingress/egress slot 34 formed in the body portion 16 for accessing the film product 12. According to FIG. 2, appropriate end caps 18 are arranged on opposite ends of the body portion 16 to provide additional light lock protection. Photographic film cartridges, such as the one disclosed in U.S. Pat. No. 5,988,895, and U.S. Pat. No. 5,715,494, both assigned to Eastman Kodak Company and hereby herein incorporated by reference, describe some of the conventional features of the cartridge 10.

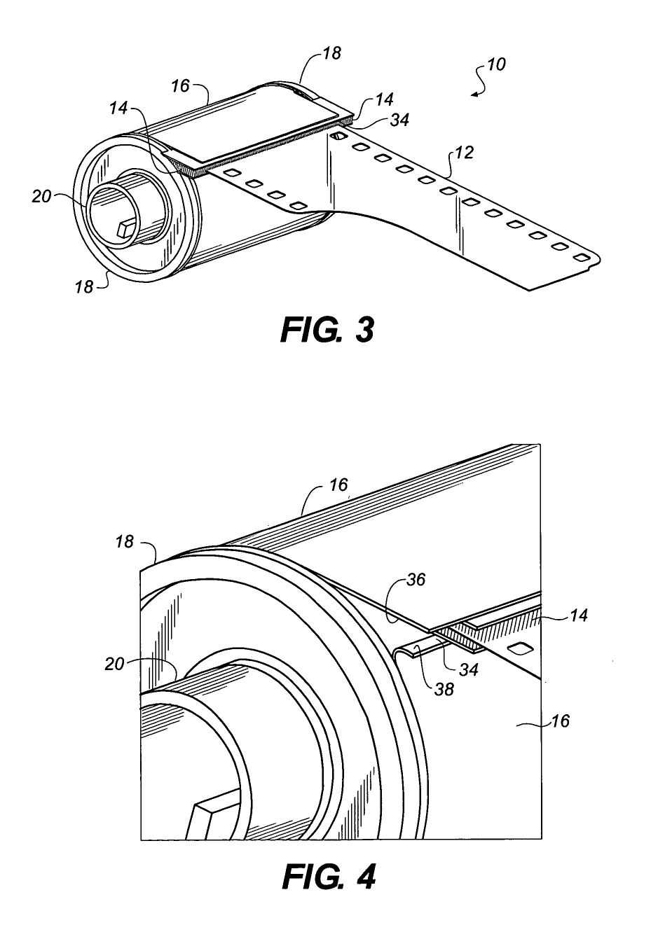

Referring to FIGS. 1-4, important to the present invention, ingress/egress slot 34 has arranged on opposite faces 36, 38, respectively, thereof a closely spaced flocked pile fiber material, also referred to as light lock materials, 14 (described in greater detail below) configured for resisting the penetration of deleterious environmentally particles such as light, dirt and dust particles into the body portion 16. As illustrated in FIG. 4, a portion of the light lock members 14 has been removed for clarity to enable viewing into the magazine 16.

Referring again to FIG. 2, an exploded view of the 35 mm film cartridge is depicted wherein the two light-lock members 14 are illustrated. A properly dyed flocked pile fiber material 14 (also referred to as a teremp) which acts as a light shield is bonded on a portion of the inner surface of the body portion 16 to the upper and lower faces 36, 38 respectively. A portion of the teremp or flocked pile fiber material 14 sufficient to allow contact and light shielding benefits for the cartridge 10 extends to that part of the lower light lock cartridge mounting face 38 that is folded over, as shown in FIGS. 2 and 4. This feature enables intimate contact of the two surfaces outboard of the film spool 20 at the egress/ingress slot 34 through which the film 12 is drawn out. The two end caps 18 complete the assembly to provide total light shielding integrity of the cartridge 10.

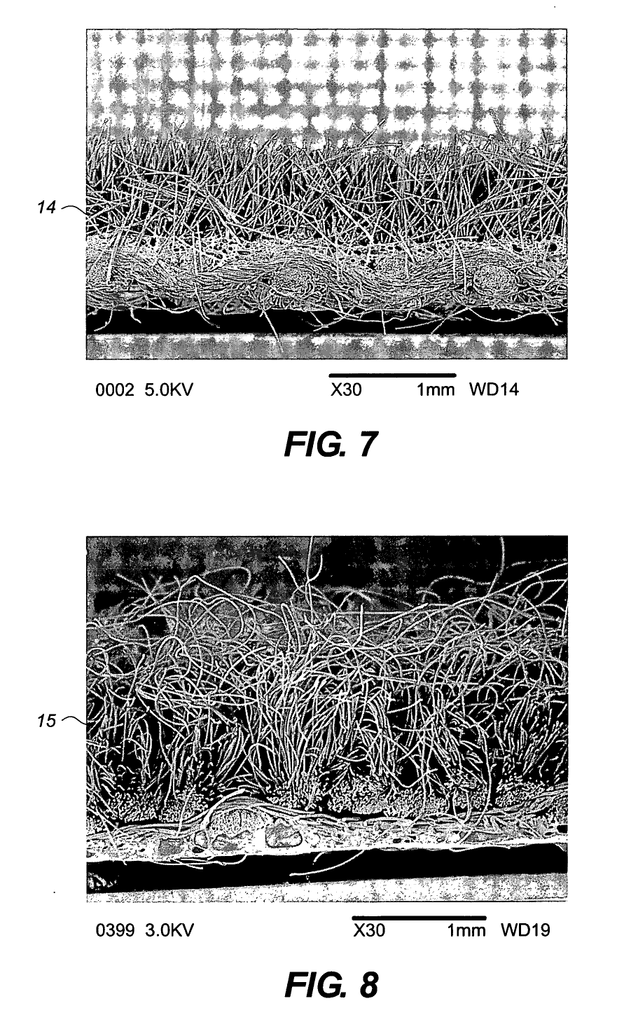

Referring to FIGS. 7 and 8, scanning electron micrographs of a cross section through both a non-woven flocked pile fiber material 14 used in the invention and a woven light lock 15 product are illustrated. As shown in FIG. 7, the random nature of the flocked pile fiber material 14 enables it to behave as an effective trap for dirt, dust and accumulated contamination thus preventing further quality issues with the photographic film product, camera systems as well as photo-finishing equipment and systems used to create the prints on a plurality of output devices and media.

Referring to FIG. 6, once flocked and slit the flocked pile fiber material 14 is bonded to opposing faces 36, 38 of the ingress/egress slot 34 by using an appropriate adhesive on a first form or magazine 16 (see FIG. 4). Typically these magazines 16 are fabricated from metal progressive punch and die stock (not shown), however they can also be produced using plastics via a process such as injection molding.

Knit fabrics are made from only one set of yarns, all running in the same direction. Some knits have their yarns running along the length of the fabric, while others have their yarns running across the length of the fabric. Looping the yarns around each other holds knit fabrics together. Knitting creates ridges in the resulting fabric. Wales are the ridges that run length wise in the fabric while courses run crosswise.

Woven fabrics are composed of two sets of yarns. One set of yarns, the warp, runs along the length of the fabric. The other set of yarns, the weft or sometimes called the fill, is perpendicular to the warp. Weaving the warp and the weft yarns over and under each other holds woven fabrics together.

A non-woven fabric is made directly from individual fibers that are matted together by forming and interlocking a web of fibers either mechanically (tangling) or chemically such as gluing, bonding or melting together.

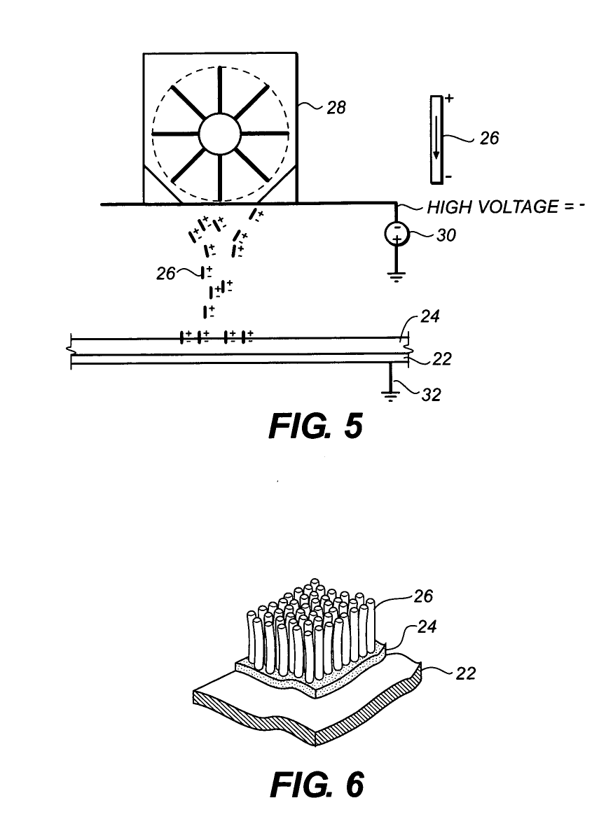

Turning to FIGS. 5 and 6, the flocking process is illustrated. Flocking is a type of raised decoration applied to the surface of a fabric or substrate 22 which an adhesive 24 is printed on the fabric in a specific pattern, and then finely chopped particles or fibers 26 are applied by means of dusting, air-brushing or electrostatic charges. The fibers 26 adhere only to the areas where the adhesive 24 has been applied, and the excess fibers are removed by mechanical means.

According to FIG. 5, one of the key advantages of the flocking process is that due to electrostatic charges, or mechanical means, the finely chopped particles or fibers 26 tend to align perpendicular to the substrate 22, thus forming a dense pile layer of the teremp 14. Typically in electrostatic flocking, the particles or fibers 26, which are constructed of a highly conductive substance, are released through a mechanical dosing system or hopper 28 that imparts a high electrostatic charge to the particles or fibers 26. The mechanical dosing system or hopper 28 that has been given a high level charge 30 is located a set distance away from the substrate 22. At the same time, the ground cloth or substrate 22, is in physical contact with electric ground 32, thus is charged with the opposite polarity of the dosing system 28. Therefore, the difference in potential between the dosing system 28 and the substrate 22 creates an electric field. Because the fibers 26 entering this charge field are made of a highly conductive material, as they are released and flow or drop through this electric field, the charges will tend to flow to one end of the particle 26, thus creating a particle 26 that is positively charged on one end and negatively charged on the other end. Therefore the particles 26 will align themselves with the electric field, thus the positive end of the particle 26 will attempt to position itself towards the negatively charged dosing system 28 and the negative end of the particle towards the substrate or electric ground 32, thus rotating into a position parallel with the charge field and perpendicular to the ground cloth or substrate 22.

According to FIG. 6, as the particles 26 move toward the substrate 22, they will accelerate and continue to align themselves parallel due to the electric field created by the difference in potential between the dosing system 28 and the substrate 22 or ground 32. Further according to FIG. 6, the substrate 22 is coated with an adhesive layer 24 that acts as an appropriate receiving layer for the charged particles 26. The negative end of the particle 26 is embedded into the un-cured adhesive layer 24 to a consistent depth that is controlled by the acceleration of said particles as a function of said applied electric field, thus generating a more consistent height of the particles 26 as measured from the substrate 22. Once the adhesive layer 24 cures, the particles 26 are fixedly bonded to the substrate 22 in a dense, random, perpendicular orientation as shown in FIG. 6.

To those skilled in the art, the application of an AC or time varying charge field in place of a DC charge field is known in the art. It is our experience, however, that an AC charge field may be more tolerant of variations with incoming flock particles.

Denier and dTex are a system of measuring the weight of a continuous filament fiber. In the United States this measurement is used to number all manufactured fibers (both filament and staple), and silk, but excludes glass fiber. The lower the number, the finer the fiber and the higher the number, the heavier the fiber.

Numerically, a denier is the equivalent to the weight in grams of 9,000 meters of a continuous filament fiber. A dTex is the equivalent to the weight in grams of 10,000 meters of a continuous filament fiber. Hence, 1 dTex=1.1 (1 denier).

Typically fibers may range from 0.6 to 45 denier and have lengths from 0.2 mm to 6.0 mm. Fineness is defined as dTex/length and is typically in a range of from 2.2 to 3.0. We prefer using flocked pile material having a denier of about 1 to 8.

A plurality of substrates, adhesives and flocked fiber materials 14 can be used to create a successful teremp for this photographic roll film cartridge invention. Substrates include thermoset elastomers of sufficient thickness and durometer or hardness to be of sufficient elastic and flexural modulus to be easily bonded onto the curved geometry of the interior wall of the shell plate for what is termed the first form or magazine 16. Some examples include, but are not limited to, natural rubber, polyisoprene, EPDM, polyurethane (both ether and ester based chemistry), nitrile, and BUNA-n, BUNA-s, polychloroprene, styrene-butadiene, EPR, epichlorohydrin and acryl elastomers. Substrates can also be produced from injection molded or extruded films of thermoplastic elastomers (TPE) including examples such as, but not limited to, commercially available Santoprene, Texin, Hytrel, Vibrathane, Vyram, Kraton, and Pellethane. These are all trade names of commercially available TPE resins suitable for melt processing methods to fabricate said substrate.

Substrates may also be injection molded or extruded from thermoplastic resins such as polyesters, polycarbonates, polyamides, polystyrenes, polyvinyl chloride, ABS, polyphenylene oxide, polyphenylene ether, Liquid Crystal Polymers (LCP) and styrene acrylonitrile. Most preferred in the aforementioned group are high impact polystyrene (HIPS), polycarbonate and ABS terpolymer. Various alloys may also be used such as polycarbonate/ABS, and Noryl grades which are polyphenylene oxide and polystyrene. Examples of metal substrates include spring steel, stainless steel, galvanized steel, aluminum, brass, tin free steel, magnesium, and cold rolled steel with galvanized steel, stainless steel and cold roll steel being the most preferred.

A plurality of adhesives can be employed to bond the light shielding teremp in place on the shell plate. Some examples of possible adhesives include a variety of hot melt adhesives, ethylene vinyl acetate polymers, cyanoacrylates & polyvinyl alcohol. We prefer using dual latex adhesive foam, olefin hot melts and polyvinyl alcohol adhesives. The adhesives may be applied to the substrate by several techniques such as spraying a dilute solution of the adhesive in a suitable solvent system.

A plurality of synthetic fiber type families can be employed for both the substrate as well as the flock fiber. These include polyolefins (such as polyethylene or polypropylene), acrylics, acetates, polyesters (such as polyethyleneterphthalate), polyamides (such as nylons), diacetates, polyvinyl chloride, polyacrylonitrile, polyvinylidene chloride, polyvinyl alcohol, and regenerated fibers such as viscose rayons, cuproammonium rayon, as well as certain natural fibers such as silk, wool and cotton or blends of cotton with acrylics and polyesters of varying compositions. We prefer using a synthetic fiber for the substrate and Nylon 6/6, polyethyleneterphalate (PET) polyester or polyethylene for the flock fiber. Extrusion melt spinning methods for any woven backing or fill with appropriate weft and warp designs would be multifilament in nature with excellent anisotropic mechanical properties such as tensile strength, and modulus with fairly high levels of inherent polymer crystallinity as well as induced through the processing steps.

In order to provide the light shielding function the yarns for the flocked pile material may be dyed by a plurality of methods. The preferred embodiment for this invention is to dye the yarn black prior to the preferred electrostatic flocking process. Methods can and do vary as a function of the yarn material selection.

Dyes that are used with yarns and fibers today can be of both a natural as well as a synthetic origin although the synthetic dyes such as mauve, indigo and alizarin (Tyrian (royal) purple) are very common in this industry. Preparation of unsaturated acids by the condensation reaction of an aromatic aldehyde with the salt of a fatty acid is very typical. In some instances a pretreatment is required such as for wool while for some yarns such as viscous rayon yarn seldom requires any pretreatment. Some fiber types also require the use of a mordant. Mordants are chemical substances that are used to promote affinity of the dye to the fiber. Alizarin, applied with an aluminum-salt mordant, was used extensively to produce bright red shades on cotton.

There are many different types of dyes contemplated for use in the invention. Dyes are usually classified according to their manner of application, the fibers for which they are used or their chemical structure. Almost all dyes fall into one of the following categories:

Vat dyes are extremely fast dyes applied particularly to cotton. Fast dyes are dyes that have strong affinity for the fiber and are more difficult to extricate after treatment. A water insoluble dye is reduced in a vat to a water-soluble compound. After the fabric is dyed, it is exposed to air or to a chemical oxidizing agent, and the dye reverts to its insoluble form.

Acid dyes are used for wool, silk and some synthetics. Unlike the vat dyes they are water-soluble and can be applied directly to the fiber.

Disperse dyes are soluble in acetate but not water. They are used to dye polyester, polyamides and other synthetic fibers.

Basic dyes include most of the first synthetic dyes. They are cationic (that is, they carry a positive electrical charge) and are used for anionic (carry a negative charge) fabrics such as wool, silk, nylon and acrylics. They can be very brilliant colors with a very high chroma or saturation. Most fluorescent dyes are basic dyes.

Reactive dyes function in an entirely different manner from other more traditional dyes. Ordinary dyes adhere to the fiber whereas reactive dyes become a part of the fiber molecule as they bond chemically. As such, they are exceptionally fast. The most important commercial member of this group of dyes is the azo dyes. These dyes are a group of organic compounds whose dyeing properties are based on a single nitrogen-to-nitrogen (—N═N—) linkage or azo bond. Thousands of azo type dyes have been developed for use on nearly every type of fiber. These are large bulky organic molecules. Azoic dyes are azo type dyes that have been specifically developed for cellulose fibers.

Azo dyes were the next major category of synthetic dyes that makes use of a diazo reaction in the resultant syntheses. In this reaction aromatic species such as amines are converted to diazonlum compounds that contains two of the diazo nitrogen-to-nitrogen linkage (—N═N—) under appropriate conditions.

Some azo dyes are used with mordants. In many cases a chelating metal is used with the dye to achieve both light and wet fastness. This is critical property to the garment industry for instance. Without the chelating agent the azo group is susceptible to photochemical (and in particular ultra violet radiation) attack and the chromagen can be destroyed via an azo scission. The risk of photochemical attack can be greatly reduced through the use of a chelating agent such as the O,O′-dinydroxy azo system. This addition will chelate a metal atom and prove to be a better target for the photochemical attack.

A chelate is a chemical compound composed of a metal ion and a chelating agent. Hemoglobin in blood is an example of a biological chelate where the metal ion is iron. A chelating agent is a substance whose molecules can form one or more coordinate bonds to a single metal ion. In other words, a chelating agent is a dentate ligand. If two ligands are attached to the metal ion it is a bidentate. If three are attached it is a tridentate and so on. A simple multidentate chelating agent is ethylene diamine. It has the structure; H₂N—CH₂—CH₂—NH₂.

Ethylene diamine will bond as a dentate, bidentate or tridentate with the metal ion Ni⁺2.

An exemplary list of several synthetic dyes, contemplated for use in the invention, based on their chemical classification appears below and include their noted chromophore.

| Class | Chromophore |
|---|---|
| Acridine | >C═N— and >C═C |
| Aminoketone | O═C—NH₂ |
| Anthraquinone | >C═O and >C═C |
| Azine | —C—N═C— and —C—N—C— |
| Monazo | One —N═N— linkage |
| Disazo | Two —N═N— linkages |
| Azo Trisazo | Three —N═N— linkages |
| Polyazo | Four of more —N═N— linkages |
| Azoic | The —N═N— linkage for cellulose |
| Diphenylmethane | >C═N |
| Hydroxyketone | O═C—OH |
| Indamine | Two —C═N |
| Indigoid | O═C—C═C—C═O |
| Indophenol | >C═N and >C═O |
| Lactone | >C═O |
| Methine | >C═C |
| Nitro | —NO₂ |
| Nitroso | —N═O═N—OH |
| Oxazine | —C—N═C and ═C—O—C═ |
| Phthalocyanine | >C═N |
| Quinoline | >C═O and >C═N |
| Stilbene | —N═N— and >C═C |
| Sulfur | ═C—S—O═ and ═C—S—S—O═ |
| Thiazole | >C═N— and —S—O═ |
| Triarylmethane | >C═AR═NH and >C═AR═O |
| Xanthene | —O—C₆H₄—O |

We prefer using an acid black dye #1, acid black dye # 52, vinyl sulfone reactive black dyes and appropriate combinations of azo, diasazo, anthraquinone or indolinone dyes to produce the black flocked fiber material of the invention.

In the preferred embodiment of this invention it is anticipated that some type of antistatic treatment of the teremp will be required in order to provide protection against static induced marks or defects on the roll of photographic film. The preference is that the antistatic agent is fixed on to the surface of both the teremp pile and backing or substrate. It is also the function of the applied antistatic agent to reduce or eliminate the static accumulation and movement of loose fibers, long fibers and/or tufts of loose fibers as well as common dirt and dust contamination that will affect the integrity of the film and all subsequent operations to which it is subjected.

The treatment of the light shielding fabric with an appropriate antistatic agent may be conducted at several different steps in the manufacturing of a proper teremp but the preferred embodiment of this invention is to have the treatment conducted as part of the final steps in a robust manufacturing process in order to obtain the greatest effect. Once applied the antistatic treatment on the yarn or fabric is subjected to a heat treatment to fix the antistatic agent. A typical temperature range of from 150 to 200 degree C. is used in this heat treat step. That range reflects differences in the required temperature for the various chemical families of available antistatic agents. Subsequent to the heat treatment excess antistatic agent is washed off in a water bath for upwards of ten (10) minutes at from 60 to 90 degrees C. A typical range for the amount of an antistatic agent is from 0.5 weight percent upwards of 5 weight percent. There are a variety of effective antistatic agents for polymeric yarns that are representative of cationic, anionic and nonionic surfactant type quaternary ammonium salts as well as certain amine-based compounds. Overall effectiveness depends on the base yarn and the level of antistatic agent employed during treatment.

Some antistatic agents are hydrophilic in nature and though effective for some systems and under certain environmental conditions these types are not recommended as a preferred embodiment as they are too dependent on the percent humidity of the ambient air. There is a great deal of variability in performance when the humidity is low and/or variable.

Most preferred antistat agents used in the invention include cationic surfactant quaternary salts, such as cetyl trimethyl ammonium bromide, anionic surfactant quaternary salts such as lanolin, anionic surfactant quaternary salts such as glycolic acid and anionic surfactant quaternary salts such as ammonium lauryl sulfate.

The yarns for forming the base fabric substrate and the non-woven flocked pile yarn fabric may either be the same or different from each other. The yarns may also be in the form of regular or specialty yarns such as conjugated, high bulky, fancy or the like.

The invention has been described with reference to a preferred embodiment; however, it will be appreciated that a person of ordinary skill in the art can effect variations and modifications without departing from the scope of the invention.

### Parts List

10 Complete 35 mm Cartridge Assembly
12 Photographic Film Product
14 Non-woven Flocked Light Lock Pile Fiber Materials/Teremp (2)
15 Woven Light Lock
16 Magazine/Shell Plate/Patrone/Tubular Shaped Body Portion
18 End Caps (2)
20 Rotatable Film Spool
22 Substrate Layer
24 Adhesive Layer
26 Flock Particles/Fibers
28 Dosing System/Hopper
30 High Voltage Source
32 Electric Ground
34 Ingress/Egress Slot
36 Upper Light Lock Cartridge Mounting Face
38 Lower Light Lock Cartridge Mounting Face

1. A light shielding enclosure containing a body portion for enclosing a light sensitive product and an exit slot formed in said body portion for accessing said light sensitive product, said exit slot having opposing light lock members thereon, wherein each one of said light lock members comprise closely spaced flocked pile material configured for resisting light penetration into said enclosure.

2. The light shielding enclosure recited in claim 1 wherein said flocked pile material is impervious to light.

3. The light shielding enclosure recited in claim 2 wherein said flocked pile material is dyed.

4. The light shielding enclosure recited in claim 2 wherein said flocked pile material comprises a plurality of flocked fibers having both a uniform length and denier.

5. The light shielding enclosure recited in claim 1 wherein said closely flocked pile material is adhered to a substrate, said substrate being fixedly arranged in said exit slot.

6. The light shielding enclosure recited in claim 2 wherein said substrate comprises material selected from the group consisting of: a fibrous material, a non-fibrous material, a metallic material, a polymeric material, a ceramic material, and an vitreous material.

7. The light shielding enclosure recited 2 wherein said substrate is fixedly arranged in said exit slot by bonding.

8. The light shielding enclosure recited in claim 1 wherein each one of said opposing light lock members is adhesively bonded to said housing.
